(19) United States
(12) Patent Application Publication
(10) Pub. No.: US 2001/0053827 A1
(43) Pub. Date: Dec. 20, 2001

(54) Reactivatable adhesive

(76) Inventors: Peter W. Merz, Wollerau (CH); Michael Gutgsell, Oberrieden (CH); Shingo Tsuno, Zurich (CH)

Correspondence Address: William L. Mathis, BURNS, DOANE, SWECKER & MATHIS, L.L.P., P.O.Box 1404, Alexandria, VA, 22313-1404, US

(21) Appl. No.: 09/873,187

(22) Filed: Jun. 5, 2001

(30) Foreign Application Priority Data
Jun. 6, 2000 (EP) 00 112 133.4

(51) Int. Cl. C08G 18/00

(52) U.S. Cl. 525/452

(57) ABSTRACT

Described are adhesives that in usual climatic conditions are storage stable over a certain period of time and that cure upon the application of an activation step. The inventive adhesives at room temperature have a thermoplasticity similar to butyl rubber and thus are plastically deformable upon joining of construction elements with the pressure necessary for such joining, and do not have a tendency for crack formation. In a lot of cases, said inventive consistency enables direct adhesion without the necessity of mechanical fixation.

### CROSS REFERENCE TO RELATED APPLICATIONS

This application claims the priority of European patent application No. 00 112 133.4, filed Jun. 6, 2000, the disclosure of which is incorporated herein by reference in its entirety.

### TECHNICAL FIELD

The present invention concerns reactivatable adhesives that under usual climatic conditions are storable over a certain period of time and that only cure after an activation step. The adhesives of the present invention are thermoplastic, plastically deformable at room temperature (=RT) and they cure upon application of energy.

### BACKGROUND OF THE INVENTION

The fundamental technology is known. Said technology is based on substances comprising stabilized isocyanate groups. Such isocyanate groups stabilized with amino groups or hydroxyl groups are described in the patent documents EP 0 100 507, EP 0 062 780, DE 32 30 757, DE 34 03 499, DE 34 03 500 and U.S. Pat. No. 5,710,215. According to the state of the art such specific systems are either used for adhesives that are applied at room temperature as pastes, as e.g. disclosed in EP 0 303 183, or for at room temperature solid, not plastically deformable adhesives as described in U.S. Pat. No. 4,710,215. The systems described in EP 0 303 183 and U.S. Pat. No. 5,710,215 do not have the consistency suitable for direct adherence. Adhesive systems providing direct adherence are adhesive systems that after the joining of the two substrates, in particular construction elements, have a sufficiently high strength making a mechanical fixation as it is necessary in the case of pasty systems, unnecessary.

The reactive hotmelts described in the patent U.S. Pat. No. 5,710,215 show a sufficiently high early strength at room temperature, however, they are not plastically deformable and they are brittle upon application of pressure, similar to e.g. candle wax. During the joining, such brittle feature is disadvantageous, since a tolerant joining and a positioning of the two construction elements with regard to each other is impossible. Furthermore, said reactive hotmelts according to the state of the art that comprise a high crystalline amount, do not possess the desired elastic properties that are necessary for the joining of construction elements with different deforming behavior in order to reduce detrimental tension peaks in the joining area.

Pasty adhesive with substances comprising stabilized isocyanate groups have the disadvantage that they bear the danger of contamination. Such a danger of contamination by the adhesive is unsuitable for the production of modules, in which the adhesive is already applied to the substrate, construction element etc., and in this state is transported to the production line.

### BRIEF SUMMARY OF THE INVENTION

Hence, it is a general object of the invention to provide adhesives that overcome the disadvantages of the above described systems, that are storable over a certain period of time under usual climatic conditions and that cure after an activation step.

Now, in order to implement these and still further objects of the invention, which will become more readily apparent as the description proceeds, the adhesive is manifested by the features that it does not react with humidity, is touchable at room temperature, is plastically deformable after the joining and directly adherent without mechanical fixation, and curing after an activation by means of energy. In particular, the adhesives of the present invention, at room temperature, have a thermoplasticity similar to butyl rubber and are thus plastically deformable curing the pressing needed for the joining of construction elements, and they have no tendency for crack formation. Said consistency of the adhesive according to the present invention, in a lot of cases, enables a direct adherence without the need of mechanical fixation.

### DETAILED DESCRIPTION OF THE INVENTION

The adhesives of the present invention are characterized in that they do not react with humidity, are touchable at room temperature, plastically deformable after joining, directly adherent without mechanical fixation, and curing after activation by means of energy. The adhesives of the present invention preferably comprise:

A) at least one hydroxyl group, amino group or mercapto croup comprising, at room temperature plastically deformable thermoplastic,

B) at least one solid, at least two isocyanate groups comprising substance whereby the surface of said substance is deactivated with active hydrogen groups carrying compounds, and wherein the ratio of isocyanate groups to active H-atoms is in favor of the isocyanate groups.

Dependent on the use of the adhesives, they can furthermore comprise at least one further component C such as plasticizers, thixotropic agents, fillers and additives. In the scope of the present invention, additives comprise e.g. catalysts, drying agents, pigments, antioxidants, flame retardants, adhesion promoters etc.

The hydroxyl groups comprising thermoplastic A) can be built up in several manners: e.g. by chain extension of an isocyanate groups comprising prepolymer with a polyol, in particular a diol, e.g. ethane diol, propane diol, butane diol, hexane diol, low molecular weight propylene glycols, hydroquinone-di(2-hydroxyethyl)ether, bisphenol ethoxylate, 1,4-cyclohexane dimethanol, N,N′-bis(hydroxyethyl)piperazine etc., or by termination of the isocyanate groups of a higher molecular prepolymer with e.g. mercapto groups or amino groups comprising hydroxyl compounds, such as e.g. aminoethanol, N-methyl aminoethanol, mercaptoethanol etc. Another possibility is the termination with bifunctional amino groups or mercapto groups comprising compounds, such as e.g. hindered diamine compounds, mercapto ethylamine etc.

The isocyanate groups comprising prepolymer is produced according to known methods at temperatures of 50 to 100° C., preferably at about 80° C., under vacuum or optionally after establishing an inert gas atmosphere, and optionally in the present of a catalyst. Said prepolymers are reaction products of isocyanate groups comprising substances, such as e.g. 1-isocyanato-3,3,5-trimethyl-5-isocyanatomethylcyclohexane (isophorondiisocyanate), 4,4′-diphenylmethanediisocyanate, hexamethylenediisocyanate, perhydro-2,4′-diphenylmethanediisocyanate and perhydro-4,4′-diphenylmethandiisocyanate, 2,4-toluenediisocyanate and 2,6-toluenediisocyanate etc., with any compound reactive with isocyanate groups, whereby the conversion usually is stoichiometric, i.e. one isocyanate groups comprising monomer per H-active group. In a preferred embodiment, the polyol is linear, i.e. bifunctional and selected from the group of polyether glycols with a molecular weight between 400 and up to above 20'000. Furthermore, for optimizing the rheology during application of the adhesive to the substrate, further polyols can be admixes that are solid at room temperature, such as e.g. polyesters, polycarbonates etc., however, only in such an amount that the resulting thermoplastic remains plastically deformable at room temperature and does not have any tendency for crack formation after deformation.

The solid at least two isocyanate groups comprising substance B, for reasons of storage stability, is insoluble in the thermoplastic A) as well as in other liquid components C, such as e.g. plasticizer, polyether glycols etc. Said substance B) is an isocyanate groups comprising substance such as those e.g. listed in U.S. Pat. No. 5,710,215. The stabilization of isocyanate groups with active hydrogen groups carrying compounds is also described in DE 32 30 757 or U.S. Pat. No. 5,710,215. Dependent on the particle size of the solid, due to the surface deactivation, such substances have different ratios of groups that upon cracking of the particles are active to groups that are activated by cleavage of the surface protecting group.

For the adhesive of the present invention, the ratio of isocyanate groups to active H-atoms is in favor of the isocyanate groups. The content of the very reactive H-atoms, e.g. the amino groups, preferably is only as high as needed for the stabilization of the solid, isocyanate groups comprising substances.

For the activation, from the outside energy is applied, whereby several energy forms, such as thermic, vibratory and electromagnetic energy forms, are suitable. For thermic energy application e.g. heating by circulating air, hot air blower, heating sleeves etc. can be mentioned; for vibratory energy application ultrasonics are possible; and for electromagnetic energy forms infrared, microwaves, high frequency etc. are suitable.

Because of the advantageous combination of features, the inventive adhesives are e.g. very well suited for the provision of vehicle pane modules, in which the inventive adhesive is already applied as mounting adhesive by the pane provider. With the vehicle producer, the adhesive according to the present invention is activated by means of energy and cured. The application of energy can be made either shortly before the mounting of the pane or in already joined state.

Furthermore, the new adhesives are touchable at room temperature, and therefore bear no danger of contamination. Due to their plastically deformable thermoplasticity at room temperature, which is similar to butyl rubber, they are tolerant during the mounting of a pane and directly adherent, making a mechanical fixation, e.g. with mounting support or belt, unnecessary.

The inventive adhesives can be conveyed by means of a squeezer, with so called pumping installations, at enhanced temperature between 50° C. and 100° C. This kind of conveying is suitable for both, the production of modules as well as for the direct joining of two substrates.

Starting from modules or separate substrates and adhesives, adhesive joins can be produced in that the substrate provided with a bead of inventive adhesive is joined with a second substrate such that the adhesive is in contact with the second substrate, whereby the adhesive prior or after the joining of the substrates is activated by application of energy.

The invention is now further described by means of examples. Said examples are intended to further illustrate the invention, however, they shall not restrict the scope of the invention in any way.

### EXAMPLE 1

Production of a hydroxyl group comprising thermoplastic A) that is plastically deformable at room temperature

To 800 g of an isocyanate groups comprising prepolymer with an isocyanate content of 2.85%, produced from a polypropylene diol with a molecular weight of 2000 and 4,4′-diphenylmethane diisocanate, 15.7 g butenediol-1,4 are admixed and maintained at 80° C. under vacuum. The resulting prepolymer with an isocyanate content of 1% was combined with monoethylamine in stoichiometric amount (NCO/NH₂=1/1).

### EXAMPLE 2

Production of a solid and stabilized isocyanate groups comprising paste B)

45 g of a dimerised toluene diisocyanate, Desmodur TT (available from Bayer AG), were dispersed in 53 g of a polypropylene diol with a molecular weight of 4000 and 2.3 g of a polypropylene diamine, Jeffamin D400 (available from Huntsman).

### EXAMPLE 3

Production of an adhesive of the invention

To 72 g freshly produced and warm (about 80° C.) thermoplastic A according to example 1, the following compounds were added in the following sequence, 17 g of paste B according to example 2, 2.5 g of the same polypropylene diol as in example 2, 0.9 g Jeffamin D400, 7.5 g carbon black and 0.06 g 58% bismuth trisneodecanoate in neodecaneic acid. Under vacuum, the composition was homogeneously mixed. The resulting adhesive did not react with humidity, was storage stable for several weeks in a standardized climate (23° C., 50% relative humidity), touchable at room temperature and plastically deformable. After heat curing in a heating by circulating air, 10 minutes at 140° C., the adhesive had a strength of about 8 MPa and an elongation at break of about 500%.

### EXAMPLE 4

Use of the inventive adhesive according to example 3 for the production of a complete pane module including a mounting adhesive.

Because of the practically not present danger of contamination, the pane module, produced according to usual methods but using the adhesive of example 3, is robust in handling. In order to protected it from extraordinary contamination risks by e.g. dust particles, it is preferably transported to the production line, e.g. at the vehicle producer, in a container, however, due to the inventive adhesive no further measures are needed. Delivery and processing preferably is performed within about 4 to 6 weeks. Shortly before or after the mounting, the adhesive is activated for curing.

After the mounting of the pane, the adhesive, dependent on the time of the activation step, is thermoplastically deformable and, due to its high cohesion is directly adherent without mechanical fixation aids. Said “ready-to-mount” pane module has the advantage that the vehicle producer has not to apply the adhesive himself and that it can leave this step to the glass producers.

While there are shown and described presently preferred embodiments of the invention, it is to be distinctly understood that the invention is not limited thereto but may be otherwise variously embodied and practiced within the scope of the following claims.

1. A reactivatable, thermoplastic adhesive that does not react with humidity, is touchable at room temperature, plastically deformable after joining and directly adherent without mechanical fixation and curing after activation by means of energy.

2. The reactivatable adhesive of claim 1 wherein said adhesive comprises:
A) at least one at room temperature plastically deformable thermoplastic comprising hydroxyl groups and/or amino groups and/or mercapto groups, and
B) at least one solid, at least two isocyanate groups comprising substance, whereby the surface of said solid substance is deactivated with active hydrogen groups carrying compounds.

3. The reactivatable adhesive of claim 2 wherein
said thermoplastic A) is selected from the group consisting of thermoplastics that are obtainable by chain extension of an isocyanate groups comprising prepolymer with a polyol, in particular a diol, or by termination of the isocyanate groups of a higher molecular weight prepolymer with e.g. mercapto groups or amino groups containing hydroxyl compounds or bifunctional amino groups or mercapto groups containing compounds.

4. The reactivatable adhesive of claim 1 additionally comprising at least one component C), selected from the group consisting of plasticizers, thixotropic agents, fillers, additives, and mixtures thereof.

5. A pane module with a coat or bead, respectively, of reactivatable thermoplastic adhesive of claim 1.

6. A method for the production of a pane module of claim 5 wherein a bead of an adhesive of claim 1 is built up on a pane.

7. The method of claim 6 wherein the coat has been made by means of a pressing instrument at temperatures between 50° C. and 100° C.

8. A method for the production of an adhesive joint wherein a substrate provided with a bead of an adhesive of claim 1 is joined with a second substrate such that the adhesive is in contact with said second substrate, whereby the adhesive prior to or after the joining of the substrates is activated by energy application.

9. The method of claim 8 wherein the energy application is an application of thermic energy, vibratory energy or electromagnetic energy.
